(19) United States
(12) Patent Application Publication
(10) Pub. No.: US 2008/0086682 A1
(43) Pub. Date: Apr. 10, 2008

(54) MARKUP LANGUAGE TEMPLATE CONVERSION

(76) Inventors: Brett W. Derricott, Salt Lake City, UT (US); Douglas M. Weber, South Weber, UT (US)

Correspondence Address: Kunzler & McKenzie, 8 EAST BROADWAY, SUITE 600, SALT LAKE CITY, UT, 84111, US

(21) Appl. No.: 11/538,466

(22) Filed: Oct. 4, 2006

(51) Int. Cl. G06F 17/00; G06F 9/45

(52) U.S. Cl. 715/239; 717/137

(57) ABSTRACT

An apparatus, system, and method for markup language Web page template conversion includes providing an XHTML template file and converting the XHTML file to XSL. The conversion may be carried out through a converter XSL file, which, when loaded in memory together with the XHTML template file, is applied to the XHTML file to convert it to an XSL template. The converter XSL file recognizes instances of pre-defined classes or IDs within the XHTML file, represents those instances in XSL code, and generates an XSL statement for inserting content associated with the class or ID within the element.

### BACKGROUND OF THE INVENTION

1. Field of the Invention

This invention relates to the conversion of files from one format to another, and more particularly to the conversion of markup language files from one format to another.

2. Description of the Related Art

It is often useful in designing, creating, viewing, and manipulating pages used in the World Wide Web portion of the Internet to separate a Web page's content and its presentation. For example, some content management systems are able to perform their functions when such separation is carried out.

HTML is the most common of Web page languages, and the most widely known. HTML files may contain both content and formatting information, in which case the information will apply only to a single Web page. Alternatively, stylesheets, such as those created in the CSS language, may be used to set the format for all documents created under it, giving several pages the same general appearance rather than having to format each individually.

The use of XML to define data elements on a Web page is increasing among software engineers, though it is still less common than HTML. Less common still is XSL, which is used to transform XML data into various presentation formats. However, it has been found that separating a Web page's content and its presentation in the less common and more difficult XML and XSL is more useful in many respects than HTML, even when used in conjunction with CSS files.

As compared to HTML, Web developers are less likely to be exposed to or have experience with XML and XSL, given that they are more sophisticated and difficult to learn than other languages, and require a substantial educational investment. XHTML, however, an XML-compliant version of HTML, is increasing in popularity. XHTML is more accessible and easier to learn than XSL. Without knowledge of XSL, however, creating XHTML files will not allow a Web page programmer to create an XSL template for use with XML data.

From the foregoing discussion, it is apparent that a need exists for an apparatus, system, and method to convert XHTML files into XSL templates, which may be used with XML content to create Web pages in desired formats.

### SUMMARY OF THE INVENTION

The present invention has been developed in response to the present state of the art, and in particular, in response to the problems and needs in the art that have not yet been fully solved by currently available conversion tools. Accordingly, the present invention has been developed to provide an apparatus, system, and method for markup language conversion that overcome many or all shortcomings in the art.

In one aspect of the invention, an apparatus for converting a markup language template includes a converter module configured to convert an XHTML template to an XSL template. In one embodiment, the converter module comprises a recognition module configured to recognize instances of pre-defined classes or IDs within the XHTML file, and a representation module configured to represent the instances of pre-defined classes or IDs in XSL code.

In a further aspect of the invention, a method of converting a markup language template includes providing an XHTML file and converting the XHTML file to an XSL file. In one embodiment, converting the XHTML file includes finding an element within the XHTML file with a pre-defined class or ID and creating a copy of the element for use within a new XSL template file. The method may further include generating an XSL statement for inserting content associated with the class or ID within the element.

In a further aspect of the invention, a signal bearing medium tangibly embodying a program of machine-readable instructions executable by a digital processing apparatus to perform operations to convert a markup language template file includes the operations of loading an XHTML file into memory, loading a converter XSL file into memory, applying the converter XSL file to the XHTML file, and converting the XHTML file to XSL. In one embodiment, the operation of converting the XHTML file comprises traversing the file node by node.

In a further aspect of the invention, a Web page content management system comprises a converter module configured to convert an XHTML template to an XSL template and a Web page creation module configured to apply the XSL template to XML data to create a Web page. In one embodiment, the converter module comprises a recognition module configured to recognize instances of pre-defined CSS classes or IDs within the XHTML file, the converter module further comprising a representation module configured to represent the instances of pre-defined classes or IDs in XSL code.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments illustrated in the appended drawings, which depict only typical embodiments of the invention and are not to be considered limiting of its scope, in which:

FIG. 1 is a schematic block diagram illustrating an embodiment of a content management system comprising an embodiment of a markup language template conversion apparatus according to the present invention;

FIG. 2 is a schematic block diagram illustrating an embodiment of a markup language template conversion apparatus according to the present invention;

FIG. 3 is a schematic flow chart diagram illustrating an embodiment of a content management method comprising an embodiment of a markup language template conversion method according to the present invention;

FIG. 4 is a schematic flow chart diagram illustrating an embodiment of a markup language template conversion method according to the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

The described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

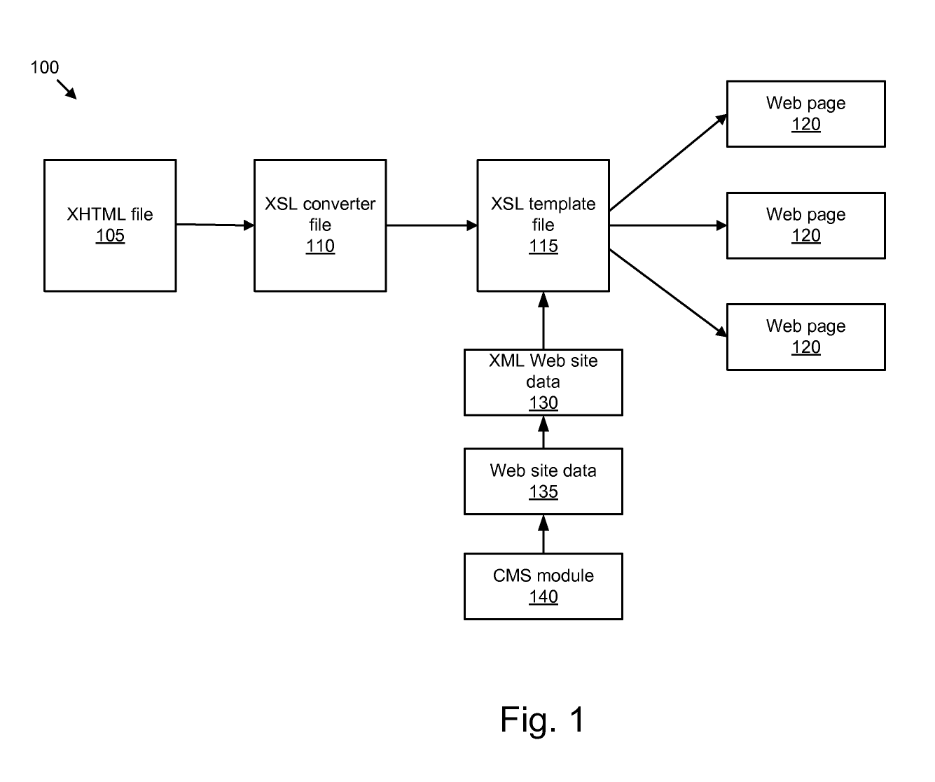

Referring first to FIG. 1, a content management system 100 comprises several components, including components making it possible to convert or transform an XHTML file into an XSL file, which is used as a template for the creation of Web pages. The system 100 comprises an XHTML file 105 that can be created by a programmer with a minimum of training, often with the assistance of Web design software. The XHTML file 105 may contain code representing format and layout of a Web page, as well as Web page content. The system 100 further comprises an XSL converter file 110, which functions to transform the XHTML file 105 into an XSL template 115. The XSL template 115 is used to create one or more Web pages 120, which may be XHTML files or files in other formats such as PHP, ASP, or JSP, as will be apparent to those skilled in the art in light of this disclosure.

The XSL template 115 may be applied to an XML Web site data file 130 to create the Web pages 120. The XML Web site data file 130 may be generated from a Web site data file or database 135, which interacts with a content management module 140 to manage the content of the Web pages 120.

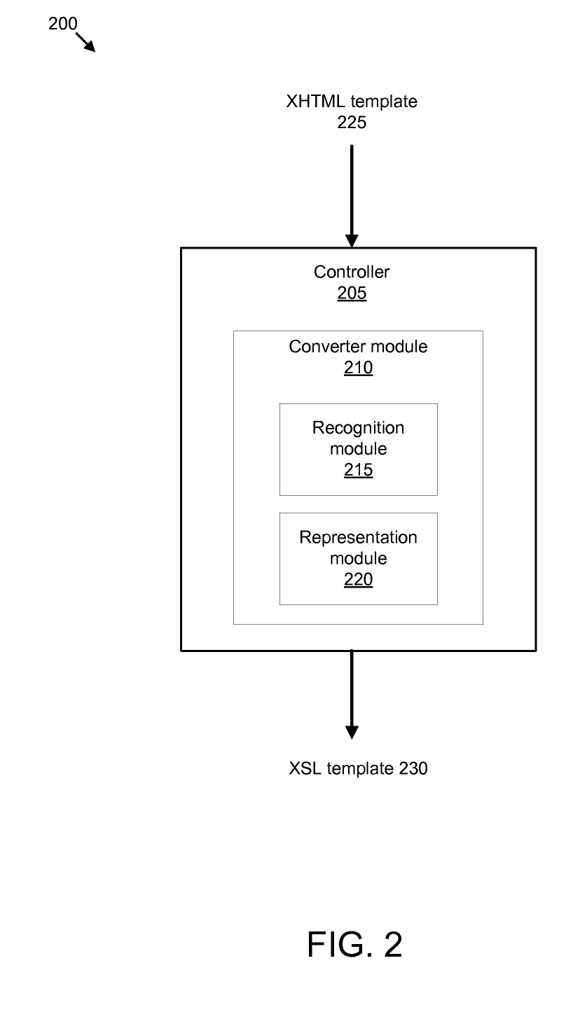

Referring now to FIG. 2, a markup language template conversion control system 200 is shown. The control system 200 comprises a controller 205, a converter module 210, a recognition module 215, and a representation module 220.

As is known in the art, the controller 205 and components may comprise processor, memory, and interface modules that may be fabricated of semiconductor gates on one or more semiconductor substrates. Each semiconductor substrate may be packaged in one or more semiconductor devices mounted on circuit cards. Connections between the modules may be through semiconductor metal layers, substrate-to-substrate wiring, or circuit card traces or wires connecting the semiconductor devices.

The converter module 210 is configured to convert an input XHTML template file 225 to an output XSL template file 230. The recognition module 215 recognizes instances of predefined CSS classes or IDs and the representation module 220 modifies and represents those instances in XSL code. The representation module 220 also represents instances of unrecognized classes or IDs and everything else in the XHTML template file 225 in the XSL template file 230 by copying the material to the XSL template file, without modifying it to represent it in XSL code.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

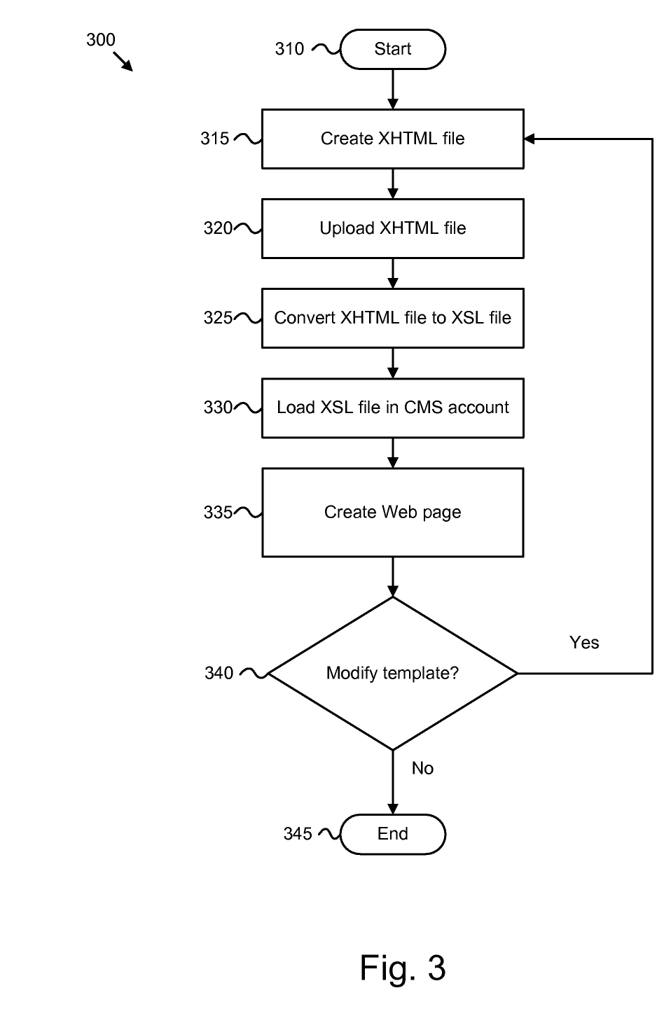

FIG. 3 shows an embodiment of a content management method 300 comprising an embodiment of a markup language template conversion method according to the present invention. The method 300 begins in block 310. In block 315, an XHTML file is created, by a programmer, software program, or other means, which contains code representing the design of a Web page and which may also contain Web page content. In block 320 the XHTML file (along with any associated assets such as images and CSS files) is uploaded to a computer content management system or other system. In block 325, the XHTML file is converted to an XSL file, the XSL file serving as a template for use by the content management system. Because the XHTML file is also considered a valid XML document, a converter XSL file can be used to transform the XHTML file into another format—in this case, XSL.

The XSL template represents the equivalent Web page format represented by the XHTML file. In block 330 the XSL file is loaded into a content management system account, and in block 335 the XSL file is used to create a Web page in XHTML, PHP, ASP, JSP, or other format. If the template needs to be modified by the original creator of the XHTML file, block 340, the method 300 returns to block 315. If no modification is needed, the method ends, block 345.

Obviously, a programmer versed in XSL may modify the XSL template directly, but the method 300 provides for modification by a programmer or user who knows only XHTML. The method 300 depicts creation and modification of design, not content; the XSL template may be used in other ways by the content management system or other system to provide and modify Web page content.

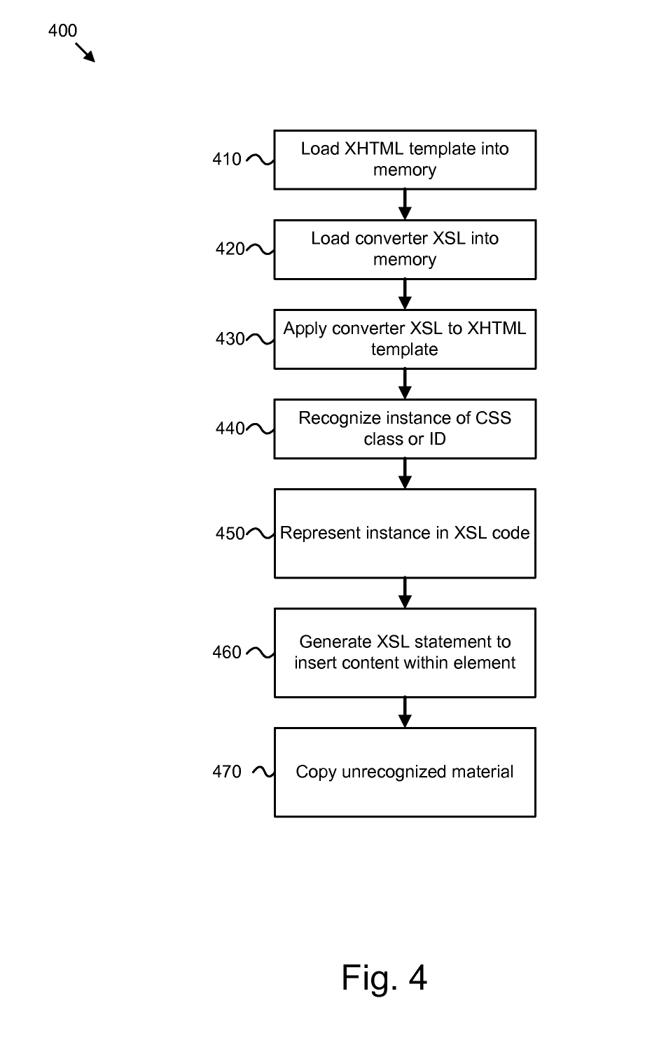

FIG. 4 illustrates an embodiment of a method 400 to convert an XHTML template file to an XSL template file, depicted generally in block 325 of FIG. 3.

In block 410 of the method 400, the XHTML template file is loaded into computer memory. This may be done by creating a new XML document in memory for the uploaded XHTML file and loading the latter into the former.

The XHTML file may contain code such as the following:

<div id=“content”></div>

In this example, the id=“content” indicates that this container is where the main page content should go.

In block 420, a converter XSL file is loaded into memory. This may be done by creating a new XML document in memory for the converter XSL file and loading the latter into the former, and then loading the file into an XSLT (XSL transform) object.

The following code section from a converter XSL file would deal with the above XHTML file code sample:

```
<xsl:template match=“*[@id = ‘content’ or @class = ‘content’ or
starts-with(@class,‘content ’)]”>
    <xsl:copy>
        <xsl:for-each select=“@*”><xsl:copy /></xsl:for-each>
        <xsl:element name=“xsl:value-of”>
            <xsl:attribute
name=“select”>pageheadtext</xsl:attribute>
        </xsl:element>
    </xsl:copy>
</xsl:template>
```

In block 430, the converter XSL file is applied to the XHTML template file. The converter XSL file looks through the XHTML file for code that it recognizes. While other templating systems require proprietary tags to be imbedded in the template file, this process allows a developer to use widely known CSS classes or IDs to indicate editable areas within the XHTML template file. In this way, the converter XSL file traverses the XHTML file node by node, i.e., from one class or ID to another, instead of having to parse the file line by line.

In block 440 of the method 400, the converter file recognizes instances of CSS classes or IDs. In the above example, the converter XSL file code finds the element (a <div> in this case) with either an ID or class called “content.”

In block 450, the converter XSL file represents the found instance of the class or ID in a new XSL template file. In the above example, the converter XSL file creates a copy of the element for use within the XSL template. All attributes of the element are preserved, resulting, in this example, in the XSL code:

<div id=“content”><xsl:value-of select=“pageheadtext”/></div>

In block 460, the appropriate XSL statement for inserting the content within the element is generated. Using the above example, this may comprise the code:

<xsl:value-of select=“pageheadtext”/>

When the final Web page is published, the content created by a user of the content management system module 140 will be inserted automatically into this element. The same process occurs for all editable areas of a template, including page title, navigation, etc.

In block 470, unrecognized material in the XHTML file, such as unrecognized classes or IDs, is copied into the resulting XSL template file. Any content contained within these unrecognized classes or IDs will be copied into the template and appear on all Web pages created with the XSL template file. If desired, certain recognized classes or IDs, such as a footer containing a copyright notice, may be modified with XSL code but be designated as reusable content so as to appear on all Web pages created with the XSL template file.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for converting a markup language template, the apparatus comprising:
an XHTML template;
a converter module configured to convert the XHTML template to an XSL template.

2. The apparatus of claim 1, wherein the converter module comprises a recognition module configured to recognize instances of pre-defined classes or IDs within the XHTML file.

3. The apparatus of claim 2, wherein the converter module further comprises a representation module configured to represent the instances of recognized pre-defined classes or IDs in XSL code.

4. The apparatus of claim 3, wherein the representation module is further configured to copy instances of unrecognized material in the XHTML file to the XSL template.

5. A method of converting a markup language template file, the method comprising:
providing an XHTML file;
converting the XHTML file to an XSL file.

6. The method of claim 5, wherein the XHTML file comprises an XHTML template file.

7. The method of claim 5, wherein converting the XHTML file comprises converting the XHTML file to an XSL template file.

8. The method of claim 5, wherein converting the XHTML file comprises recognizing instances of pre-defined CSS classes or IDs and representing those instances in XSL code.

9. The method of claim 5, wherein converting the XHTML file comprises finding an element within the XHTML file with a pre-defined class or ID and creating a copy of the element for use within a new XSL template file.

10. The method of claim 9, further comprising generating an XSL statement for inserting content associated with the class or ID within the element.

11. The method of claim 7, further comprising using the XSL template file to create one or more pages of a Web site.

12. The method of claim 7, further comprising modifying the XHTML file and converting the modified XHTML file to an XSL template file.

13. The method of claim 7, further comprising using the XSL template file in a content management system.

14. A signal bearing medium tangibly embodying a program of machine-readable instructions executable by a digital processing apparatus to perform operations to convert a markup language template file, the operations comprising:
loading an XHTML file into a memory;
loading a converter XSL file into the memory;
converting the XHTML file to XSL by applying the converter XSL file to the XHTML file.

15. The signal bearing medium of claim 14, wherein the XHTML file comprises an XHTML template file, and wherein the operation of converting the XHTML file comprises converting the XHTML template file to an XSL template file.

16. The signal bearing medium of claim 14, wherein the operation of converting the XHTML file comprises recognizing instances of pre-defined CSS classes or IDs and representing those instances in XSL code.

17. The signal bearing medium of claim 14, wherein the operation of converting the XHTML file comprises finding an element within the XHTML file with a pre-defined class or ID and creating a copy of the element for use within a new XSL template file, and further comprising the operation of generating an XSL statement for inserting content associated with the class or ID within the element.

18. The signal bearing medium of claim 14, wherein the operation of converting the XHTML file comprises traversing the file node by node.

19. A content management system, the system comprising:
a converter module configured to convert an XHTML template to an XSL template;
a Web page creation module configured to apply the XSL template to XML data to create a Web page.

20. The system of claim 19, wherein the converter module comprises a recognition module configured to recognize instances of pre-defined CSS classes or IDs within the XHTML file, the converter module further comprising a representation module configured to represent the instances of pre-defined classes or IDs in XSL code, the representation module further configured to copy unrecognized material in the XHTML file to the XSL template.
